(19) United States
(12) Patent Application Publication
(10) Pub. No.: US 2018/0140503 A1
(43) Pub. Date: May 24, 2018

(54) WEARABLE VIBRATORY STIMULATION DEVICE AND OPERATIONAL METHOD THEREOF

(71) Applicant: KOREA INSTITUTE OF SCIENCE AND TECHNOLOGY, Seoul (KR)

(72) Inventors: Choong Hyun KIM, Seoul (KR); Changmook CHUN, Seoul (KR); Seung-Jong KIM, Seoul (KR); Byung-Mo OH, Seoul (KR); Han Gil SEO, Seoul (KR); Gangpyo LEE, Seoul (KR)

(73) Assignee: KOREA INSTITUTE OF SCIENCE AND TECHNOLOGY, Seoul (KR)

(21) Appl. No.: 15/404,238

(22) Filed: Jan. 12, 2017

(30) Foreign Application Priority Data
Nov. 24, 2016 (KR) 10-2016-0157575

(51) Int. Cl. A61H 23/00; A61H 3/00

(52) U.S. Cl. CPC A61H 23/00; A61H 3/00; A61H 2201/501; A61H 2205/106; A61H 2201/5058

(57) ABSTRACT

The present disclosure provides a wearable vibratory stimulation device and an operational method thereof, the wearable vibratory stimulation device including: a data storing unit configured to store a protocol of vibratory stimulation; a vibrating unit configured to generate vibratory stimulation having a predetermined amplitude and frequency based on the protocol; a measuring unit configured to measure the amplitude and frequency of vibratory stimulation generated from the vibrating unit; and a control unit configured to control the vibrating unit and the measuring unit, wherein the control unit controls the vibrating unit by a comparison between vibratory stimulation based on the protocol and vibratory stimulation generated from the vibrating unit.

### CROSS-REFERENCE TO RELATED APPLICATION

This application claims priority to Korean Patent Application No. 10-2016-0157575, filed on Nov. 24, 2016, and all the benefits accruing therefrom under 35 U.S.C. § 119, the contents of which in its entirety are herein incorporated by reference.

### BACKGROUND

### 1. Field

The present disclosure relates to a wearable vibratory stimulation device and an operational method thereof, and more particularly, to a wearable vibratory stimulation device and an operational method for operating the same, which helps walking assistance and rehabilitation of persons who experience inconvenience in moving by brain nervous system diseases.

### 2. Description of the Related Art

In order to help rehabilitate persons who experience inconvenience in moving by paralysis of certain parts of the bodies as a result of ageing of the population or various diseases, methods of delivering external stimulation to bodies are being applied.

According to earlier methods, it was reported that when microvibratory stimulation is applied to tendons or muscles, sensory nerves are stimulated to alleviate paralysis symptoms, making muscles move more easily and relieving muscle stiffness.

As an example of related art according to this earlier method, a vibratory stimulation device 1000 described in Korean Patent No. 1383059 as shown in FIG. 7 recognizes a walking motion of a wearer through a motion capturing unit 1005, compares it with a database 1002, and applies vibratory stimulation to a specific part of the walking trainee through an exciting unit 1004.

However, because the vibratory stimulation device 1000 described in related art is a device that corrects walking by applying vibration to muscles under the premise that the wearer may walk, effectiveness is very low to wearers having great difficulties in walking.

Furthermore, the vibratory stimulation device 1000 described in related art only applies vibratory stimulation through comparison with the database 1002, and does not consider the influence of this vibratory stimulation on the wearer or providing an optimum stimulation effect, failing to give efficient stimulation to wearers in practice.

### RELATED LITERATURES

Prior art: Korean Patent No. 1383059

### SUMMARY

Therefore, the present disclosure is directed to solving the above problem, and providing a personalized optimum vibratory stimulation protocol in the operation of a wearable vibratory stimulation device that offers a walking assistance function to patients or handicapped people who experience inconvenience in moving by the occurrence of a stiffness or rigidity phenomenon in muscles due to brain nervous system malfunction.

To achieve the above technical objective, the present disclosure provides a wearable vibratory stimulation device including: a data storing unit configured to store a protocol of vibratory stimulation; a vibrating unit configured to generate vibratory stimulation having a predetermined amplitude and frequency based on the protocol; a measuring unit configured to measure the amplitude and frequency of vibratory stimulation generated from the vibrating unit; and a control unit configured to control the vibrating unit and the measuring unit, wherein the control unit controls the vibrating unit by a comparison between vibratory stimulation based on the protocol and vibratory stimulation generated from the vibrating unit.

Furthermore, the control unit of the present disclosure may include a determination unit configured to determine efficiency of the vibratory stimulation by a comparison between reference Hoffmann's reflex and Hoffmann's reflex after the vibratory stimulation.

Furthermore, the present disclosure may provide the wearable vibratory stimulation device further including a communication unit configured to exchange information and data with the control unit and the data storing unit via wired or wireless communication, wherein the communication unit may select and apply a protocol of vibratory stimulation in real time according to a motion condition of a wearer.

Furthermore, the vibrating unit of the present disclosure may apply vibratory stimulation to a muscle of a wearer.

Furthermore, the control unit of the present disclosure may reflect a motion condition of a wearer in real time, and select a protocol of the vibratory stimulation according to the motion condition.

Also, the present disclosure provides an operational method of the above wearable vibratory stimulation device, including: preparing a protocol of vibratory stimulation; operating a vibrating unit according to the protocol of vibratory stimulation to generate vibratory stimulation having a predetermined amplitude and frequency; applying the vibratory stimulation to a wearer; and comparing actual vibratory stimulation applied to the wearer with vibratory stimulation of the vibrating unit.

Furthermore, the preparing of a protocol of vibratory stimulation according to the present disclosure may include identifying whether there is a latest vibratory stimulation protocol and applying the protocol through a communication unit.

Furthermore, the present disclosure may provide the operational method of the wearable vibratory stimulation device further including measuring efficiency of the vibratory stimulation by a comparison between reference Hoffmann's reflex and Hoffmann's reflex after the vibratory stimulation.

The present disclosure generates vibratory stimulation using information of vibratory stimulation protocol recorded in the data storing unit, i.e., amplitude, frequency, stimulation duration and rest period, and delivers the vibratory stimulation to a wearer, thereby maximizing the walking assistance and rehabilitation treatment effect for patients or handicapped people who experience inconvenience in moving.

### BRIEF DESCRIPTION OF THE DRAWINGS

FIG. 1 is a schematic block diagram showing a configuration of a wearable vibratory stimulation device according to an embodiment of the present disclosure.

FIG. 2 is a schematic flowchart showing an operational method of a wearable vibratory stimulation device according to an embodiment of the present disclosure.

FIG. 3A is a schematic concept diagram and FIG. 3B and FIG. 3C are real test photographic images showing vibratory stimulation delivery to a wearer and Hoffmann's reflex measurement according to an embodiment of the present disclosure.

FIG. 4 shows a vibratory stimulation protocol for evaluating a focal muscle vibratory stimulation effect according to an embodiment of the present disclosure.

FIG. 5 is a graph showing a vibratory stimulation effect according to an embodiment of the present disclosure.

FIG. 6A and FIG. 6B are graphs showing an effect of varying frequencies and amplitudes using a vibratory stimulation device according to an embodiment of the present disclosure.

FIG. 7 is a schematic block diagram showing a configuration of a vibratory stimulation device according to related art.

### DETAILED DESCRIPTION OF MAIN ELEMENTS

100: Wearable vibratory stimulation device
110: Control unit
111: Determination unit
120: Data storing unit
130: Measuring unit
140: Vibrating unit
150: Communication unit

### DETAILED DESCRIPTION

Hereinafter, a wearable vibratory stimulation device and an operation method for operating the same according to the present disclosure will be described through the exemplary embodiments of the present disclosure with reference to the accompanying drawings.

Prior to description, in many embodiments, elements having the same configuration are described in a representative embodiment using the same symbols, and different elements are only described in the other embodiments.

Generally, when external physical stimulation is applied to a human body, the human body recognizes the stimulation through sensory neurons, carries signals to the brain and the spinal cord and sends control signals through motor neurons to respond to the stimulation.

Furthermore, if stimulation is applied to peripheral nerves, M-waves (waves of muscles) transmitted directly to muscles through motor nerves and the stimulation are transmitted to the spinal cord along sensory peripheral nerves and to motor nerves through single synaptic connection and return to the muscles, and in this instance, the presence or absence of impairment in the nervous system may be verified by comparing latency of Hoffmann's reflex with threshold and quantifying a difference therebetween.

That is, in case that a neurological disorder occurs, there is a tendency that the size of Hoffmann's reflex is relatively larger than the case of normal persons.

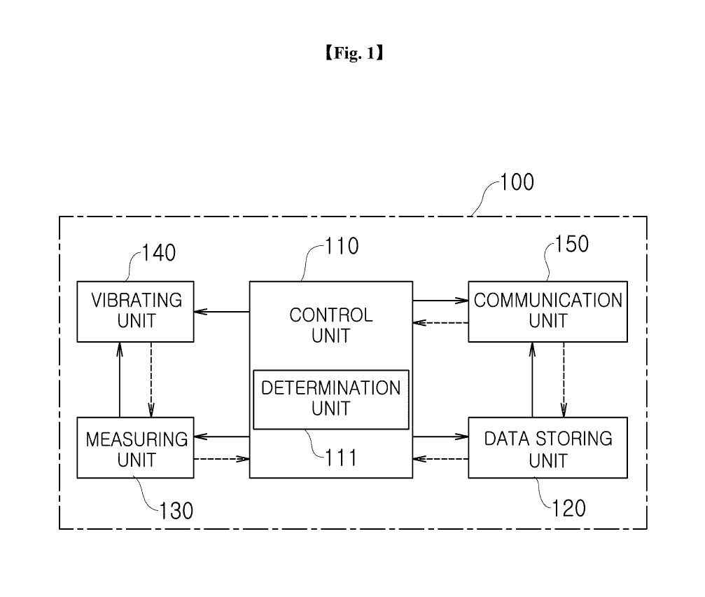

FIG. 1 is a schematic block diagram showing a configuration of a wearable vibratory stimulation device 100 according to an embodiment of the present disclosure.

Referring to FIG. 1, the wearable vibratory stimulation device 100 according to an embodiment of the present disclosure includes a control unit 110 including a determination unit 111, a data storing unit 120, a measuring unit 130, a vibrating unit 140 and a communication unit 150.

The data storing unit 120 stores a protocol of vibratory stimulation, and the vibrating unit 140 may generate vibratory stimulation having a predetermined amplitude and frequency based on the protocol.

Furthermore, the measuring unit 130 may measure the amplitude and frequency of vibratory stimulation applied to a wearer (not shown) wearing the wearable vibratory stimulation device 100, and the vibrating unit 140 and the measuring unit 130 may be controlled through the control unit 110.

On the other hand, the control unit 110 may control the vibrating unit 140 by a comparison between vibratory stimulation based on the protocol and vibratory stimulation generated by the vibrating unit 140. The control of the vibrating unit 140 will be described in more detail below.

The control unit 110 may be configured as a compact computer or a mobile device, and particularly, may further include the determination unit 111 to determine the efficiency of vibratory stimulation by a comparison between reference Hoffmann's reflex of the wearer and Hoffmann's reflex of the wearer after the vibratory stimulation.

Furthermore, the control unit 110 may further include a filter (not shown) to predict vibratory stimulation applied to a user more accurately from signals related to body movement information of the wearer including noise.

Moreover, the wearable vibratory stimulation device 100 according to an embodiment of the present disclosure may further include the communication unit 150 to exchange information and data with the control unit 110 and the data storing unit 120 wiredly or wirelessly, and the communication unit 150 may select and apply a protocol of vibratory stimulation in real time according to the motion (movement) condition of the wearer.

Accordingly, the control unit 110 may reflect the motion condition of the wearer in real time, and select a protocol of vibratory stimulation in real time according to the motion condition of the wearer.

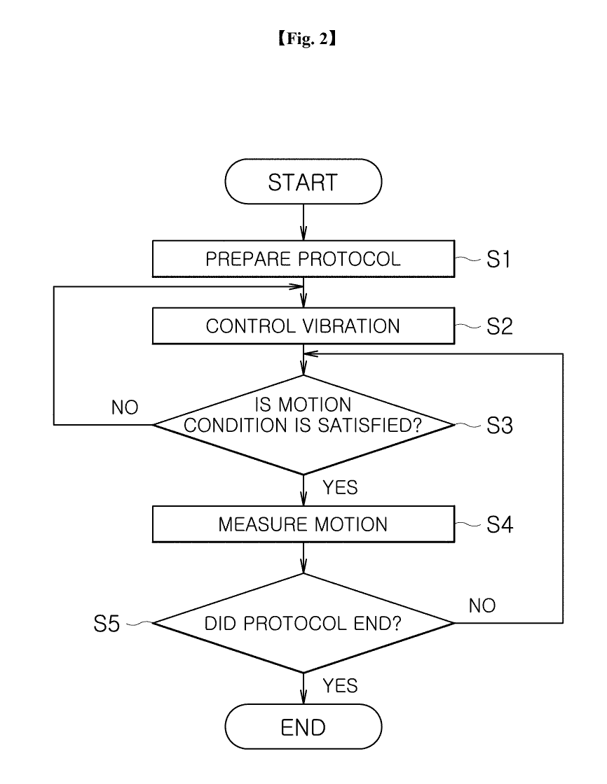

FIG. 2 is a schematic flowchart showing an operational method of the wearable vibratory stimulation device 100 according to an embodiment of the present disclosure.

As shown in FIG. 2, upon operation, the wearable vibratory stimulation device 100 enters a protocol setting step first and then identifies whether there is a latest vibratory stimulation protocol, to prepare a protocol necessary for vibratory stimulation (S1). This is a process for maximizing the walking assistance and rehabilitation effect for a wearer through an optimum neurological disorder reduction effect. Furthermore, as described above, connection to an external device may be established through the communication unit 150, making it possible to identify whether there is a latest protocol, and if necessary, proceed with updates.

Subsequently, after protocol preparation is completed, the protocol installed in the data storing unit 120 is read, and the vibrating unit 140 is allowed to operate based on the protocol to generate vibration having a predetermined amplitude and frequency and apply the vibration to a minimal muscle (S2). Furthermore, at the same time, the measuring unit 130 measures the applied amplitude and frequency and compares it with a preset value (S3), and the vibratory stimulation device 100 is controlled to operate within a tolerance range (S4).

When application of a set of protocols ends, verification determines whether the operation is completed in accordance with the entire vibratory stimulation scheme (S5), and in case that a full set of protocols are executed, vibratory stimulation is stopped.

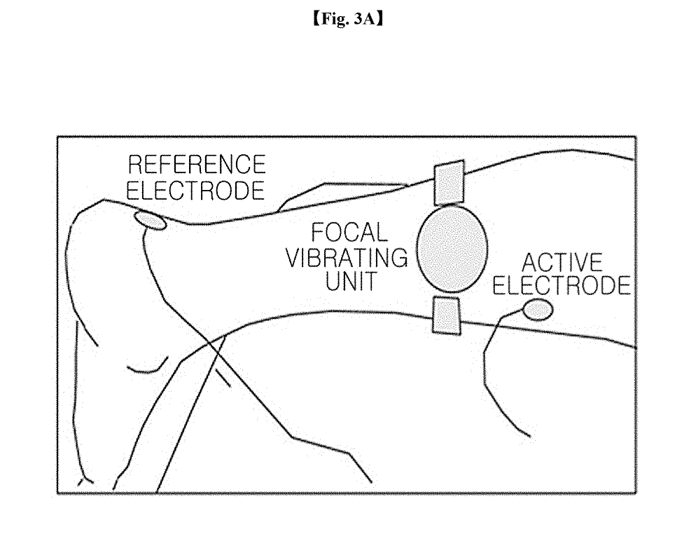

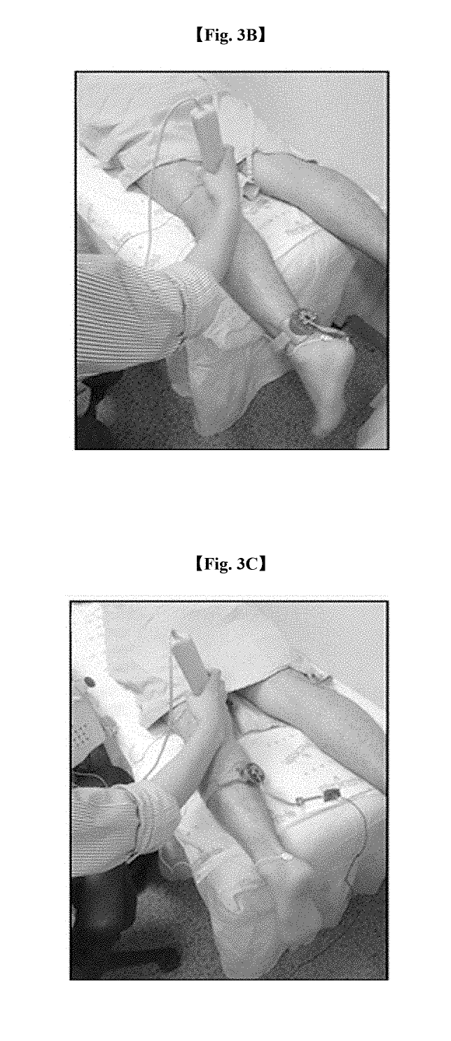

FIG. 3A is a schematic concept diagram and FIG. 3B and FIG. 3C are real test photographic images showing vibratory stimulation delivery to a wearer and Hoffmann's reflex measurement according to an embodiment of the present disclosure.

As shown in FIG. 3A to FIG. 3C, the vibratory stimulation device 100 according to an embodiment of the present disclosure applies direct vibratory stimulation to muscle at a local part, and thus, may enhance the neurological disorder reduction effect as compared to applying vibratory stimulation to tendon.

FIG. 4 shows a vibratory stimulation protocol for evaluating a focal muscle vibratory stimulation effect according to an embodiment of the present disclosure. Referring to FIG. 4, reference Hoffmann's reflex that serves as a criterion is measured before applying vibratory stimulation. Subsequently, vibration is applied to muscle at a local part, and Hoffmann's reflex of a wearer is measured at each point in time of 1, 5, and 10 minutes after the onset of vibratory stimulation while vibratory stimulation is being applied. Furthermore, after vibratory stimulation is applied for 10 minutes in total, vibration is paused for 5 minutes, and Hoffmann's reflex is measured at each point in time of 1 and 5 minutes after the pause of vibratory stimulation. Subsequently, there is a 5-minute rest to remove all effects that may appear due to previous vibratory stimulation. Furthermore, the reference Hoffmann's reflex measured before vibratory stimulation and the remaining five Hoffmann's reflexes are compared and evaluated. A total of three sets of Hoffmann's reflex comparative experiments are carried out, and the results are evaluated.

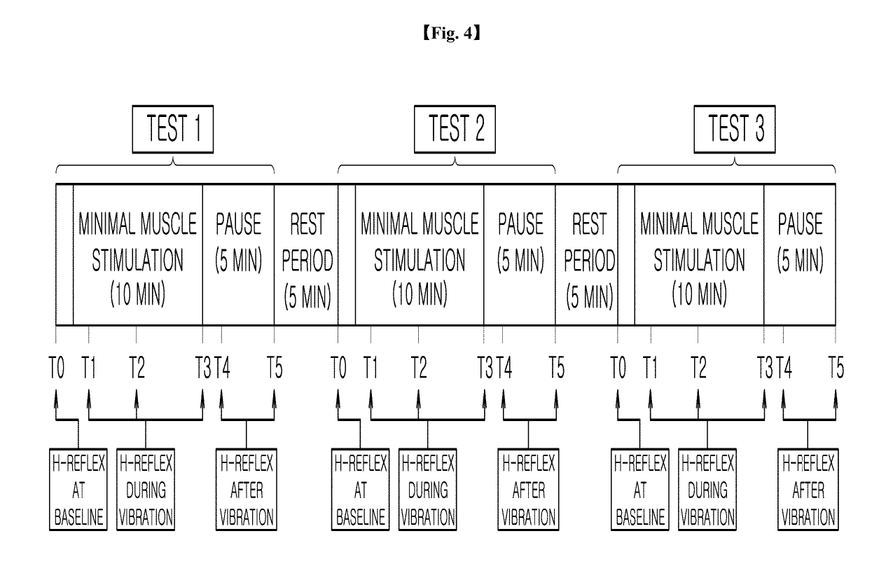

FIG. 5 is a graph showing a vibratory stimulation effect according to an embodiment of the present disclosure, and vibratory stimulation is applied to Achilles tendon and gastrocnemius muscle and changes in Hoffmann's reflex are compared using the method of FIG. 4 as described above. Referring to FIG. 5, it can be seen that all of the two experiments have reductions in the size of Hoffmann's reflex when vibratory stimulation is applied, and it can be expected that neurological disorders will reduce through vibratory stimulation.

On the other hand, it can be seen that when vibratory stimulation is applied to Achilles tendon, Hoffmann's reflex reduces by about 10% in comparison with before stimulation, while when vibratory stimulation is applied to gastrocnemius muscle, Hoffmann's reflex reduces by 25% or more. Accordingly, it can be seen that a neurological disorder reduction effect is much better when applying vibratory stimulation to muscle than tendon.

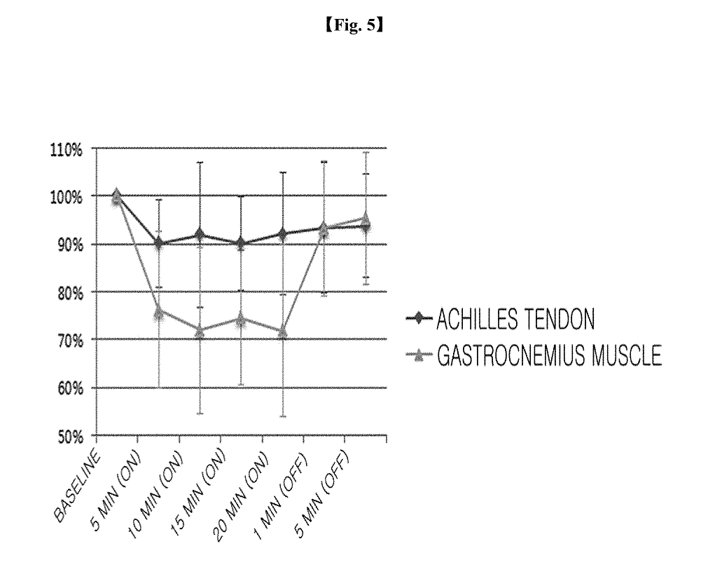

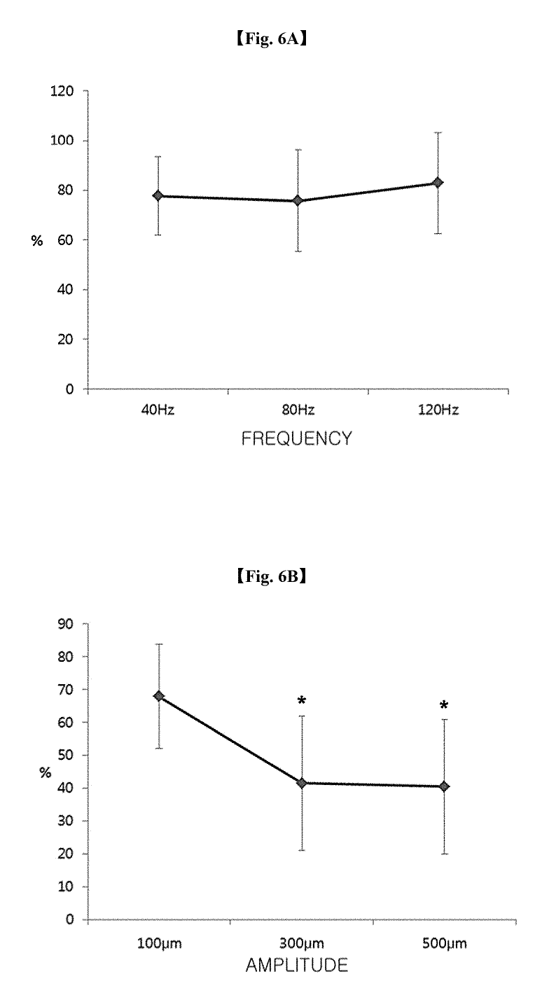

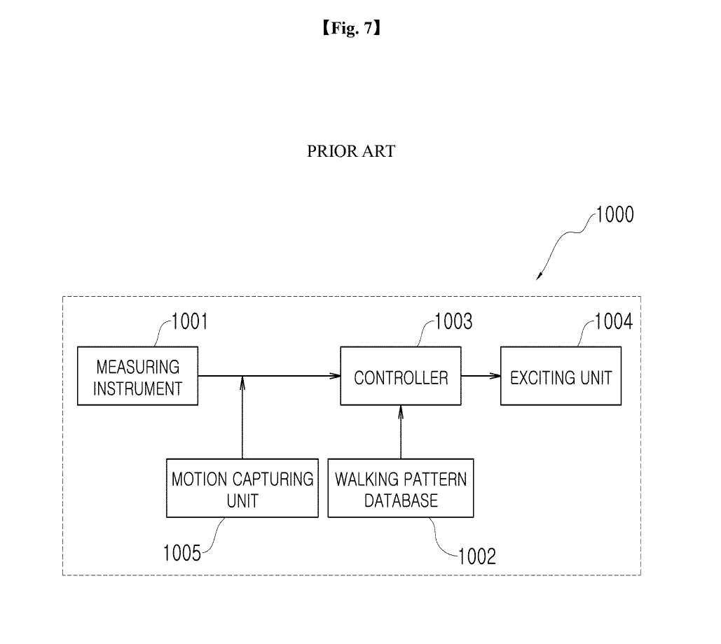

Furthermore, in the above test, when applying the test protocol to muscle at a local part (gastrocnemius), the influence of frequency and amplitude of vibratory stimulation on human body is recognized. In this instance, the test is performed on non-handicapped persons with variables of three frequencies of 40, 80, and 120 Hz and three amplitudes of 100, 300, and 500 μm, and the results are shown in FIGS. 6A and 6B.

As shown in FIG. 6A, it can be seen that as a result of applying vibratory stimulation to gastrocnemius muscle at varying frequencies of 40, 80, 120 Hz when the amplitude is 100 μm, Hoffmann's reflex reduces by 20% or more in comparison with before vibratory stimulation, and as a result of statistical analysis, it is found that a difference between frequencies has no significance. However, when the frequency is 40 Hz, rotation safety of the vibrating unit 140 is poor, and when the frequency is 120 Hz, too high rotation rate may cause discomfort for wearers, and there is a risk of reduced safety of the entire vibratory stimulation device 100, so it is determined that the frequency of vibratory stimulation is preferably 80 Hz.

FIG. 6B shows the results of applying vibratory stimulation to gastrocnemius muscle at varying amplitudes of 100, 300, and 500 μm with the same frequency of 80 Hz. When the amplitude is 100 μm, Hoffmann's reflex reduces by 30% or more in comparison with before vibratory stimulation, while when the amplitude is 300 μm and 500 μm, each Hoffmann's reflex reduces by approximately 60% in comparison with before vibratory stimulation, and thus, it can be seen that its effect is superior to the case where the amplitude is 100 μm.

Furthermore, as a result of statistical analysis, it is found that the influence on Hoffmann's reflex reduction as a function of amplitude has no significance when the amplitude is 300 μm and 500 μm. However, when the amplitude is 500 μm, the instance of discomfort wearers feel due to over-stimulation is observed, and thus, the amplitude of vibratory stimulation is preferably 300 μm.

With reference to the above description, those with skills in the technical field to which the present disclosure belongs will appreciate that the present disclosure can be practiced in another particular form without modifying the technical spirit or essential features.

Therefore, it should be understood that the embodiments described hereinabove are for the purpose of illustration in all aspects, but not intended to limit the present disclosure to the disclosed embodiments, the scope of the present disclosure is defined by the appended claims rather than the above detailed description, and all modifications or variations derived from the meaning and scope of the appended claims and an equivalent concept thereof should be construed as falling within the scope of the present disclosure.

### INDUSTRIAL APPLICABILITY

The present disclosure may provide a wearable vibratory stimulation device for walking assistance and an operational method thereof, and through this, may be used to develop medical assistant equipment or medical equipment for rehabilitation designed to provide walking assistance to persons who experience inconvenience in moving by brain nervous system diseases.

What is claimed is:

1. A wearable vibratory stimulation device, comprising:
a data storing unit configured to store a protocol of vibratory stimulation;
a vibrating unit configured to generate vibratory stimulation having a predetermined amplitude and frequency based on the protocol;
a measuring unit configured to measure the amplitude and frequency of vibratory stimulation generated from the vibrating unit; and
a control unit configured to control the vibrating unit and the measuring unit,
wherein the control unit controls the vibrating unit by a comparison between vibratory stimulation based on the protocol and vibratory stimulation generated from the vibrating unit.

2. The wearable vibratory stimulation device according to claim 1, wherein the control unit comprises a determination unit configured to determine efficiency of the vibratory stimulation by a comparison between reference Hoffmann's reflex and Hoffmann's reflex after the vibratory stimulation.

3. The wearable vibratory stimulation device according to claim 1, further comprising:
a communication unit configured to exchange information and data with the control unit and the data storing unit via wired or wireless communication,
wherein the communication unit may select and apply a protocol of vibratory stimulation in real time according to a motion condition of a wearer.

4. The wearable vibratory stimulation device according to claim 1, wherein the vibrating unit applies vibratory stimulation to a muscle of a wearer.

5. The wearable vibratory stimulation device according to claim 3, wherein the control unit may reflect a motion condition of a wearer in real time, and select a protocol of the vibratory stimulation according to the motion condition.

6. An operational method of the wearable vibratory stimulation device defined in claim 1, comprising:
preparing a protocol of vibratory stimulation;
operating a vibrating unit according to the protocol of vibratory stimulation to generate vibratory stimulation having a predetermined amplitude and frequency;
applying the vibratory stimulation to a wearer; and
comparing actual vibratory stimulation applied to the wearer with vibratory stimulation of the vibrating unit.

7. The operational method of the wearable vibratory stimulation device according to claim 6, wherein the preparing of a protocol of vibratory stimulation comprises identifying whether there is a latest vibratory stimulation protocol and applying the protocol through a communication unit.

8. The operational method of the wearable vibratory stimulation device according to claim 7, further comprising:
measuring efficiency of the vibratory stimulation by a comparison between reference Hoffmann's reflex and Hoffmann's reflex after the vibratory stimulation.
